(19) United States
(12) Patent Application Publication
(10) Pub. No.: US 2023/0057374 A1
(43) Pub. Date: Feb. 23, 2023

(54) CHARGING STATION

(71) Applicant: ME ENERGY GMBH, Wildau (DE)

(72) Inventors: Alexander SOHL, Berlin (DE); Inès ADLER, Berlin (DE)

(73) Assignee: ME ENERGY GMBH, Wildau (DE)

(21) Appl. No.: 17/796,653

(22) PCT Filed: Jan. 28, 2021
(86) PCT No.: PCT/EP2021/052028

§ 371 Date: Jul. 31, 2022

(30) Foreign Application Priority Data
Jan. 31, 2020 (DE) 10 2020 102 518.1

(51) Int. Cl. B60L 53/31

(52) U.S. Cl. CPC B60L 53/31; B60L 53/54

(57) ABSTRACT

The invention relates to a charging station for charging electric vehicles, comprising a housing, a power and HMI unit, and an energy conversion unit, wherein the power and HMI unit is arranged between the front of the housing and the energy conversion unit.

The invention relates to a charging station for charging electric vehicles, comprising a housing, a power and HMI unit, and an energy conversion unit, wherein the power and HMI unit is arranged between the front of the housing and the energy conversion unit.

### STATE OF THE ART

The spread of electric vehicles powered by an electric motor is accompanied by a functioning infrastructure for charging electric vehicles. In addition to charging at the household socket, users of electric vehicles must also be given the opportunity to obtain energy in the public space. With the ranges of electric vehicles available to date, it is necessary to be able to charge vehicles outside of the home environment. Therefore, charging stations must be provided in public areas to ensure constant availability of energy for electric vehicles through a supply network.

Stationary systems for supplying electricity to stationary charging stations to recharge the traction battery of a plug-in vehicle—hybrid or electric vehicle—are known, as described, for example, in DE 10 2009 016 505 A1. The charging station itself is connected to a power rail of the power supply. An existing power grid has a connection element for outputting electrical energy to an electric vehicle.

Such a loading device has the disadvantage that it cannot be set up or dismantled flexibly. The costs of setting up and, in particular, connecting the charging device to the existing power grid are also very high.

DE 10 2017 102 251 A1 presents a stationary charging station whose interior has two installation spaces. In this way, a separation is achieved between the mains or connection area and the charging technology area. Both installation spaces are separated by a vertically arranged inner wall and are separately accessible, i.e. each has a door.

A disadvantage of such an arrangement is the low flexibility of the arrangement, for example to take into account structural conditions of the installation site. The connection area, for example, cannot be set up separately from the charging technology area. In addition, the charging station can only be flexibly expanded to a limited extent, e.g. to provide a higher charging power and/or to accommodate more charging cables for charging electric vehicles. The external dimensions of the charging station are given by the dimensions of the base frame.

It is therefore the object of the present invention to provide a charging station for charging electric vehicles, which has a structure such that various components of the charging station can be constructed separately, thus offering the greatest possible variability in the choice of the location of the charging station, as well as being expandable by any number of components.

The object is solved by means of the charging station according to claim 1. Further advantageous embodiments of the invention are set forth in the dependent claims.

The charging station according to the invention, which is suitable for charging electric vehicles, has a housing in which a power and HMI (human-machine interface) unit and an energy conversion unit are arranged.

The power and HMI unit features a display and operating device that allows a user to operate the charging station. The display and operating device has display and operating elements arranged on the front of the housing. The energy conversion unit has a device for converting a liquid and/or gaseous energy carrier into electrical energy. According to the invention, the power and HMI unit is arranged between the front of the housing and the energy conversion unit.

For the purposes of this document, the location of a unit and/or device is determined by the geometric center of the unit and/or device, i.e., a unit and/or device is represented by a point, the geometric center.

Also for the purposes of this document, the front of the housing is defined by the location of the display and operating elements, in other words the display and operating element is located at the front of the housing. The back of the housing is then the side opposite the front of the housing.

The geometric center of the energy conversion unit is located behind the geometric center of the power and HMI unit. The distance of the geometric center of the energy conversion unit has a greater distance to the front than the geometric center of the power and HMI unit.

Due to this arrangement of the power and HMI unit, the basic concept of a structure and arrangement of the units is maintained, as known from the prior art. At the same time, variability in the arrangement of the power and HMI unit and the energy conversion unit is made possible in order to also take into account, for example, local conditions when installing the charging station.

In a development of the invention, the energy conversion unit comprises a first energy conversion device and/or a second energy conversion device. For example, a fuel cell may be arranged in the first energy conversion device. The second energy conversion device then includes power electronics that convert voltage and amperage of the electric current generated by the fuel cell into energy usable by an electric vehicle to be charged.

In another embodiment of the invention, the first energy conversion device is adapted to generate kinetic energy from the liquid and/or gaseous energy carrier. The second energy conversion device is capable of converting kinetic energy into electrical energy. An internal combustion engine, which is typically a reciprocating internal combustion engine, may be disposed in the first energy conversion device. However, other designs such as Wankel engines or turbines are also possible. The internal combustion engine drives the second energy conversion device by rotation, e.g. a generator. The kinetic energy generated by the combustion engine is thus converted into electrical energy by the generator.

In another embodiment of the invention, the first energy conversion device is disposed above the second energy conversion device. This makes the first energy conversion device easier to reach in case of maintenance. Furthermore, in the case of an internal combustion engine arrangement in the first energy conversion device, vibration due to rotation can be reduced by suitable measures, e.g. installation of vibration dampers.

In another aspect of the invention, the display and operating device is disposed above the power and HMI unit. The display and operating device is then located at a height above the ground that is easily visible and accessible to a user of the charging station.

In a further embodiment of the invention, the power and HMI unit and the energy conversion unit are arranged in the housing. The housing protects the units located inside from the effects of weather as well as other unforeseeable factors, e.g. unintentional damage due to accidents or vandalism.

In another embodiment of the invention, the charging station comprises a tank unit. The tank unit has one or more tanks in which the fuel for the first energy conversion device is stored.

In a further embodiment of the invention, the tank unit is arranged in the housing. The housing protects the units located inside from the effects of weather as well as other unforeseeable factors, e.g. unintentional damage due to accidents or vandalism.

In another embodiment of the invention, the energy conversion unit is located between the power and HMI unit and the tank unit. Therefore, easy accessibility of the tank unit from several sides is ensured, since experience has shown that the tanks located in the tank unit have to be changed or filled more frequently than the other components of the charging station.

In another embodiment according to the invention, the energy conversion unit is arranged above the tank. In a particular design of this embodiment, the energy conversion unit comprises two energy conversion devices arranged side by side on the tank.

In an advantageous embodiment of the invention, the tank unit is adapted to receive one or more interchangeable tanks. The interchangeable tank can be changed individually. Due to the storage of the fuel in interchangeable tanks, the operator of the charging station is able to refill the charging station so quickly and safely that the downtime of the charging station due to a lack of fuel is kept to a minimum. The emptied interchangeable tank is filled externally, e.g. at a suitable filling station, and is ready for the next use in a charging station.

In a particularly advantageous embodiment of the invention, the charging station is modular. In particular, one or more modules can be replaced in order to be externally maintained or repaired, for example, in the event of a failure of the components arranged in the module. The charging station can then continue to be operated using the exchanged modules. Downtime is thus significantly reduced.

In addition, the power of the charging station can be adjusted to the demand. For example, if the charging station operator recognizes that there is a need for higher power output from the charging station, the module containing the energy conversion unit can be replaced with a more powerful module and/or another similar module is implemented in the charging station.

It is also possible to install standardized modules or components from different manufacturers in the charging station. This ensures that state-of-the-art components are installed in the charging station. In addition, the price development of the components is taken into account by implementing cheaper modules or components.

In another embodiment of the invention, the charging station has the power and HMI unit and energy conversion unit and/or tank unit modules. One or more modules can be replaced in order to be maintained or repaired externally, e.g. in case of failure of the components arranged in the module. The charging station can then continue to be operated using the exchanged modules. Downtime is thus significantly reduced.

In another advantageous embodiment of the invention, the modules are interconnectable. The tank unit is connected via fuel lines to the energy conversion unit, which in turn is connected via electrical lines to the power and HMI unit. Control of the energy conversion unit is thus possible by means of the power and HMI unit. The tank unit is also connected to the power and HMI unit by means of electrical lines in order to determine the filling status of the tank unit.

In another advantageous embodiment of the invention, all modules have the same width. The individual modules can therefore be arranged linearly, e.g. one behind the other, and the space required for the charging station in terms of width is thus limited.

In another embodiment of the invention, the charging station has separate partial housings. This allows separation of the individual modules. The modules can be accessed separately and independently of each other, e.g. by means of lockable flaps or doors. In case of maintenance, only authorized and responsible persons have access to the respective module.

In another embodiment of the invention, one of the partial housings is constructed from a mounting frame. A partial housing comprises a supporting mounting frame and cladding parts attached to it. The mounting frame preferably comprises light metal profiles to which the cladding parts and in particular accesses to the components of the modules, e.g. doors or flaps, are attached. One or more covers form the top, one or more base plates form the bottom side of a module.

In a further advantageous embodiment of the invention, one module is arranged in each of the separate partial housings. This allows separation of the power and HMI unit, energy conversion unit and tank unit. The modules can be accessed separately and independently of each other, e.g. by means of lockable flaps or doors. In case of maintenance, only authorized and responsible persons have access to the respective module.

In a particularly advantageous embodiment of the invention, the partial housings are arranged in an overall housing. The overall housing at least partially encloses the partial housings. The housing protects the units located inside from the effects of weather as well as other unforeseeable influences, e.g. unintentional damage due to accidents or vandalism. At the same time, the modules can be accessed separately and independently of each other, e.g. by means of lockable flaps or doors. In case of maintenance, only authorized and responsible persons have access to the respective module. In a preferred embodiment of the invention, an opening that can be reclosed with a door or cover is provided in the overall housing through which the entire charging station with all its components can be serviced.

In another preferred embodiment of the invention, the charging station comprises an exhaust system. This has the advantage that the exhaust gases produced during energy conversion can be directed out of the charging station without inconveniencing people. Preferably, the exhaust system is arranged such that at least parts of the exhaust system are arranged above the energy conversion unit and/or one or more of the energy conversion devices. In a particularly preferred embodiment of the invention, the exhaust system has an exhaust outlet arranged at the top of the overall housing and/or a partial housing. An exhaust outlet is then located here on the top of the charging station.

Exemplary embodiments of the charging station for charging electric vehicles according to the invention are shown schematically in simplified form in the drawings and are explained in more detail in the following description.

Showing:

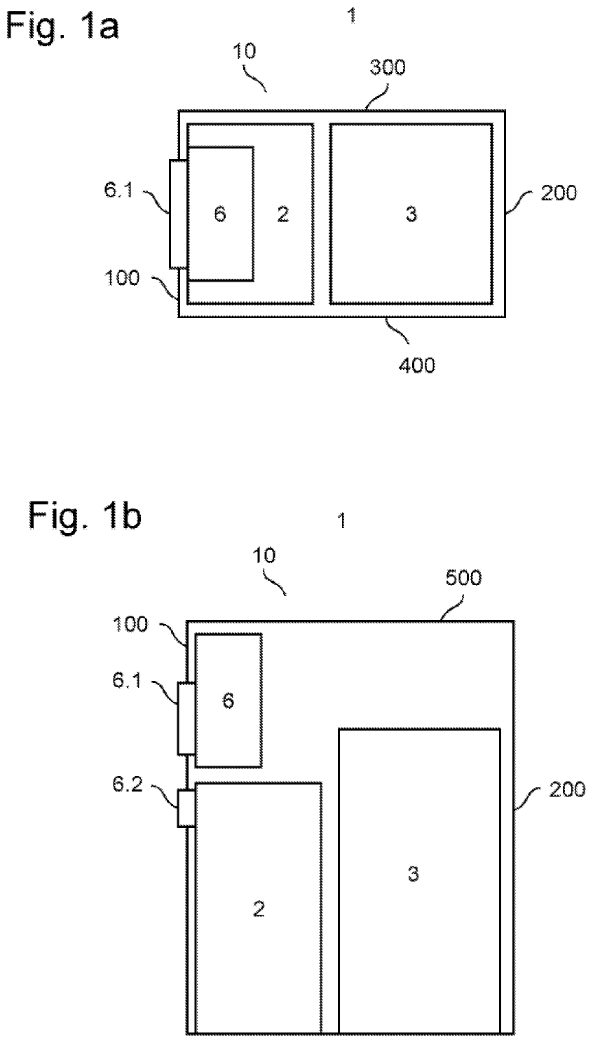

FIG. 1a: A top view of an exemplary embodiment of the charging station according to the invention.

FIG. 1b: A side view of an exemplary embodiment of the charging station according to the invention.

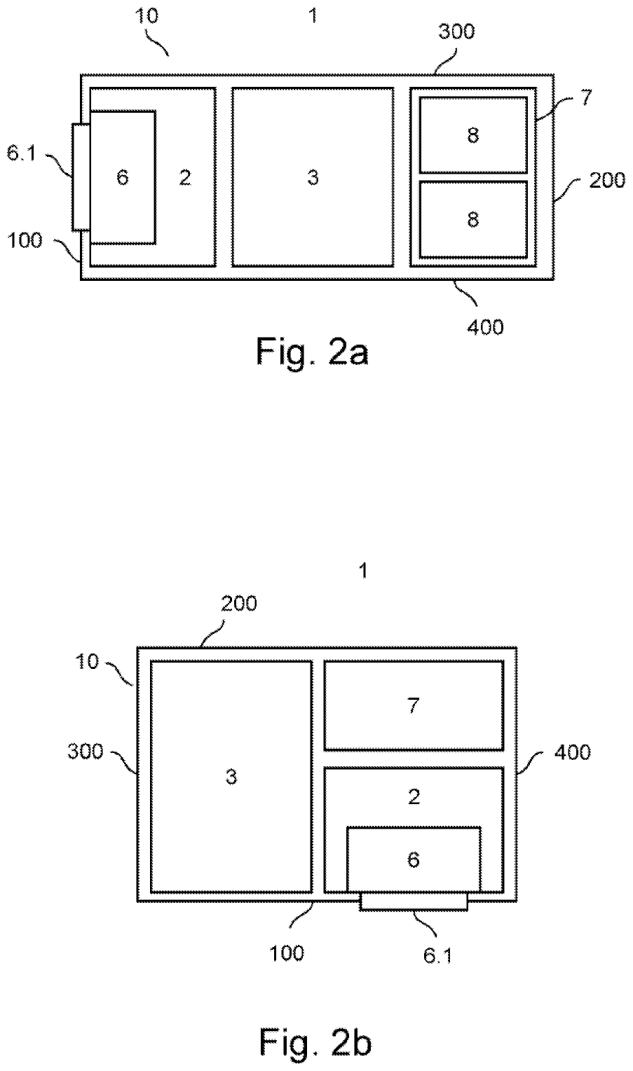

FIG. 2a: A top view of an exemplary embodiment of the charging station according to the invention.

FIG. 2b: A side view of an exemplary embodiment of the charging station according to the invention.

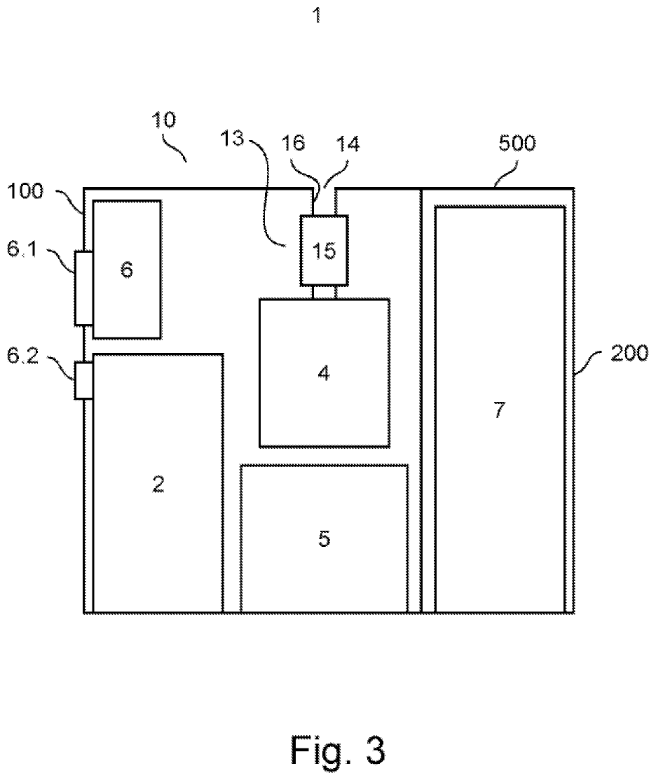

FIG. 3: A side view of an exemplary embodiment of the charging station according to the invention with an intermediate wall.

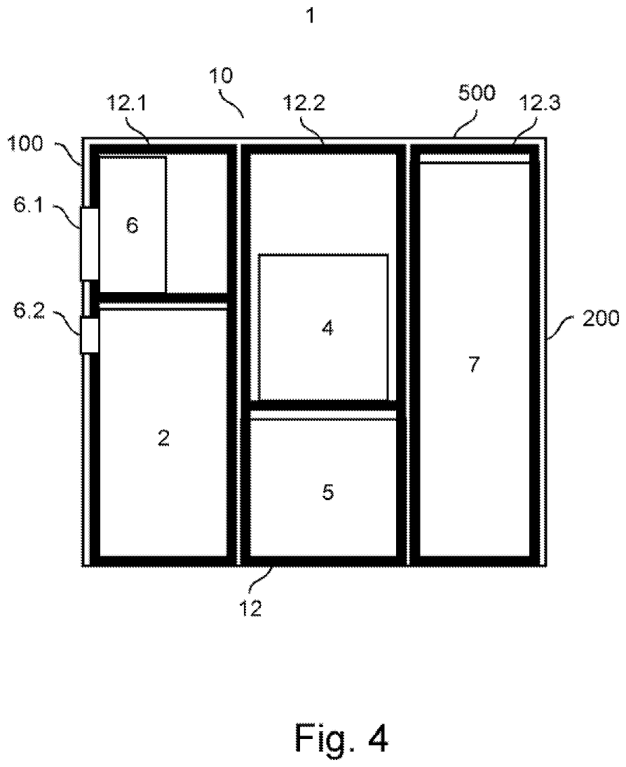

FIG. 4: A side view of an exemplary embodiment of the charging station according to the invention with an mounting frame.

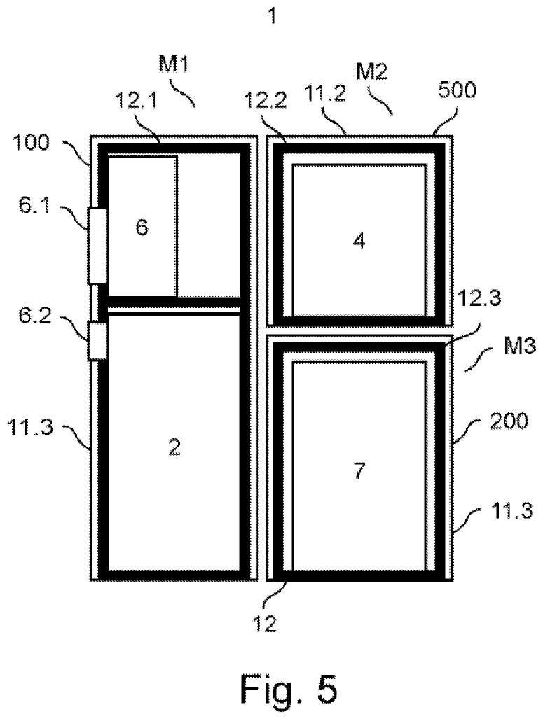

FIG. 5: A side view of an exemplary embodiment of the charging station according to the invention, modular structure.

FIG. 1 shows a view of the charging station 1 according to the invention, in which the power and HMI unit 2 and the energy conversion unit 3 are arranged within an overall housing 10. The charging station 1 has the power and HMI unit 2 and an energy conversion unit 3, which have the same width in this exemplary embodiment. The power and HMI unit 2 located between the front 100 of the housing 10 and the energy conversion unit 3. The front 100 of the housing 10 is thereby defined by the position of the display and operating element 6.1, in other words the display and operating element 6.1 is arranged at the front 100 of the housing 10 (FIG. 1a).

The power and HMI unit 2 has the display and operating device 6 arranged above the power and HMI unit 2. The display and operating device 6 has a display and operating element 6.1 on which data important to a user, such as charging current, charging duration and cost of the charging process, are displayed. In addition, a user can initiate or end the charging process and pay by means of the display and operating element 6.1. Various payment systems are possible, e.g. via different credit cards. Other payment systems are also possible, e.g. via a mobile device (smartphone). In addition, the power and HMI unit 2 has a connection device for charging cables 6.2 (FIG. 1b), which is used to charge an electric vehicle to be charged.

In this exemplary embodiment, the charging station 1 has an internal combustion engine that is installed within the first energy conversion device 4. The combustion engine is usually a piston combustion engine, but other designs such as a Wankel engine or turbine are also possible. Advantageously, the internal combustion engine is preferably operated with methanol or ethanol or a mixture of methanol and ethanol. Starter motor and fuel pump are also arranged in the first energy conversion device 4. The internal combustion engine drives the second energy conversion device 5 arranged below it by rotation, in this exemplary embodiment a generator. The kinetic energy generated by the combustion engine is thus converted by the generator into electrical energy, into an alternating current.

In an advantageous optional embodiment, two different fuels are kept ready for starting and/or operating the internal combustion engine, wherein a first fuel is used in the starting phase and a second fuel different from the first fuel is used once the engine has warmed up. Preferably, a gasoline fuel is used for the start-up phase, while further operation is then carried out using methanol and/or ethanol.

It is also possible to use a fuel cell in the first energy conversion device 4. The fuel cell can be a Direct Methanol Fuel Cell (DMFC) powered by methanol. However, other embodiments of the fuel cell are also possible, which are operated by means of ethanol or hydrogen, for example. The second energy conversion device 5 then includes power electronics that convert voltage and amperage of the electric current generated by the fuel cell into energy usable by an electric vehicle to be charged.

The two units power and HMI unit 2 and energy conversion unit 3 are arranged in an overall housing 10. Lockable doors and maintenance flaps allow access to the units.

FIG. 2 shows a top view of the charging station 1 according to the invention, in which the power and HMI unit 2, the energy conversion unit 3 and the tank unit 7 are arranged within an overall housing 10. The charging station 1 has the power and HMI unit 2, an energy conversion unit 3, and a tank unit 7. The power and HMI unit 2 is located between the front 100 of the housing 10 and the energy conversion unit 3.

The power and HMI unit 2 has the display and operating device 6 arranged above the power and HMI unit 2. The display and operating device 6 has a display and operating element 6.1 on which data important to a user, such as charging current, charging duration and cost of the charging process, are displayed. In addition, the power and HMI unit 2 has a connection device for charging cables 6.2, which is used to charge an electric vehicle to be charged.

The fuel in the charging station 1 according to the invention is stored in a tank unit 7, which is arranged between the back 200 of the charging station 1 and the energy conversion unit 3. Advantageously, the tank unit 7 has one or more interchangeable tanks 8 which can be changed individually. Due to the storage of the fuel in interchangeable tanks 8, the operator of the charging station 1 is able to refill the charging station 1 so quickly and safely that the downtime of the charging station 1 due to a lack of fuel is kept to a minimum. The emptied interchangeable tank 8 is filled externally, e.g. at a suitable filling station, and is ready for the next use in a charging station 1. Depending on the availability of space at the installation site of the charging station 1, the power and HMI unit 2, the energy conversion unit 3 and the tank unit 7 can be arranged in a linear fashion (FIG. 2a). All units have the same width in this embodiment example. The tank unit (7) can optionally also be arranged under the power unit. An arrangement of the tank unit 7 between the power and HMI unit 2 and the energy conversion unit 3 is also possible, but in principle easy accessibility of the tank unit 7 from several sides is preferable, since experience has shown that the interchangeable tank 8 arranged in the tank unit 7 are changed or filled more frequently than the other components of the charging station 1.

However, in one variant of the charging station 1, the energy conversion unit 3 may also be arranged on one side in such a way that the geometric center of the energy conversion unit 3 is located behind the geometric center of the power and HMI unit 2 (FIG. 2b), in other words the distance of the geometric center of the energy conversion unit 3 has a greater distance to the front 100 than the geometric center of the power and HMI unit 2.

The three units power and HMI unit 2, energy conversion unit 3 and tank unit 7 are arranged in an overall housing 10. Lockable doors and maintenance flaps allow access to the units.

A detailed side view of the charging station 1 according to experience is shown in FIG. 3. The charging post 1 has the power and HMI unit 2, an energy conversion unit 3, and a tank unit 7, which in this exemplary embodiment are linearly arranged and have the same width. The power and HMI unit 2 is located between the front 100 and the energy conversion unit 3. The power and HMI unit 2 has the display and operating device 6 arranged above the power and HMI unit 2. The display and operating device 6 has a display and operating element 6.1 on which data important to a user, such as charging current, charging duration and cost of the charging process, are displayed. Also arranged are the electrical connections (charging cables), each of which can be connected to an electric vehicle to be charged.

Between power and HMI unit 2 and tank unit 7 is arranged the energy conversion unit 3, which includes the first energy conversion device 4 and the second energy conversion device 5. In this exemplary embodiment, the first energy conversion device 4 is an internal combustion engine and the second energy conversion device 5 is a generator for converting the kinetic energy generated by the internal combustion engine into electrical energy. The fuel in the charging station 1 according to the invention is stored in a tank unit 7, which is arranged between the back 200 of the charging station 1 and the energy conversion unit 3. The three units power and HMI unit 2, energy conversion unit 3 and tank unit 7 are arranged in an overall housing 10. Lockable doors and maintenance flaps allow access to the units. An intermediate wall 9 separates the tank unit 7 from the energy conversion unit 3 to keep any leakage from the tank unit 7 away from the power and HMI unit 2 and the energy conversion unit 3. The charging station also has an exhaust system 13 through which the exhaust gases produced during energy conversion can be conducted to the outside. In addition to an exhaust pipe 16, the exhaust system 13 optionally includes one or more catalytic converters 15. The exhaust system 13 is arranged above the first energy conversion device, the internal combustion engine 4, and directs the exhaust gases upwards through an exhaust outlet 14 out of the overall housing 100 of the charging station 1.

FIG. 4 shows the structure of the charging station 1 according to experience by means of mounting frames 12.1, 12.2, 12.3. The charging post 1 has the power and HMI unit 2, an energy conversion unit 3, and a tank unit 7, which in this exemplary embodiment are linearly arranged and have the same width. The power and HMI unit 2 is located between the front 100 and the energy conversion unit 3. The power and HMI unit 2 has the display and operating device 6 arranged above the power and HMI unit 2. The display and operating device 6 has a display and operating element 6.1 on which data important to a user, such as charging current, charging duration and cost of the charging process, are displayed. Also arranged are the electrical connections (charging cables), each of which can be connected to an electric vehicle to be charged. Between power and HMI unit 2 and tank unit 7 is arranged the energy conversion unit 3, which includes the first energy conversion device 4 and the second energy conversion device 5. In this embodiment, the first energy conversion device 4 is a fuel cell and the second energy conversion device 5 is a generator for converting the direct current generated by the fuel cell into an alternating current. The charging station also has an exhaust system through which the gases produced during energy conversion can be conducted to the outside. This exhaust system is located above the first energy conversion device, the fuel cell, and directs the exhaust gases upward out of the overall charging column housing.

The fuel in the charging station 1 according to the invention is stored in a tank unit 7, which is arranged between the back 200 of the charging station 1 and the energy conversion unit 3. The three units power and HMI unit 2, energy conversion unit 3 and tank unit 7 are arranged in an overall housing 10. Lockable doors and maintenance flaps allow access to the units.

Power and HMI unit 2, tank unit 7 and the energy conversion unit 3 are each arranged in a mounting frame 12.1, 12.2, 12.3. A mounting frame 12.1, 12.2, 12.3 preferably comprises light metal profiles to which one or more cladding parts are attached, forming the housing 10. Access points, e.g. doors or flaps, allow easy access to the components installed in the units, particularly in the event of maintenance or for refueling or replacing the interchangeable tanks 8 arranged in the tank unit 7.

FIG. 5 shows the modular structure of the charging station 1 according to experience by means of partial housings 11.1, 11.2, 11.3 and mounting frames 12.1, 12.2, 12.3. The charging station 1 has the power and HMI unit module M1, the energy conversion unit module M2 and the tank unit module M3, the modules M1, M2, M3 are linearly arranged in this embodiment example and have the same width. In this exemplary embodiment, the tank unit module M3 with the tank 7 is arranged below the energy conversion unit module M2 with a first energy conversion device (here a fuel cell) 4.

Each module M1, M2, M3 is arranged in a separate partial housing 11.1, 11.2, 11.3. A partial housing 11.1, 11.2, 11.3 comprises a supporting mounting frame 12.1, 12.2, 12.3 and flat cladding parts attached thereto. The mounting frame 12.1, 12.2, 12.3 preferably comprises light metal profiles to which the cladding parts and in particular accesses to the components of the modules M1, M2, M3, e.g. doors or flaps, are attached. One or more covers form the top 500, one or more bottom plates form the bottom side of a module M1, M2, M3.

The partial housings 11.1, 11.2, 11.3 can be reached separately from one another through flaps or doors in order to allow easy access to the components installed in the modules

M1, M2, M3, in particular in the event of maintenance or for refueling or replacement of the interchangeable tanks 8 arranged in the tank unit 7. The modular design of charging station 1 offers several advantages: One or more modules M1, M2, M3 can be exchanged in order to be maintained or repaired externally, e.g. in case of failure of the components arranged in the module M1, M2, M3. The charging station 1 can then continue to be operated by means of the exchanged modules M1, M2, M3. Downtime is thus significantly reduced.

In addition, the power of the charging station 1 can be adjusted to the demand. For example, if the operator of the charging station 1 recognizes that there is a need for higher power output from the charging station 1, the module M2 containing the energy conversion unit 3 can be replaced with a more powerful module M2 and/or another similar module M2 is implemented in the charging station 1.

It is also possible to install standardized modules M1, M2, M3 or components from different manufacturers in the charging station 1. This ensures that state-of-the-art components are installed in the charging station 1. In addition, the price development of the components is taken into account by implementing cheaper modules M1, M2, M3 or components.

### LIST OF REFERENCE SIGNS

1 Charging station

2 Power and HMI unit

3 Energy conversion unit

4 First energy conversion device

5 Second energy conversion device

6 Display and operating device

6.1 Display and operating element

6.2 Connection device for charging cable

7 Tank unit

8 Interchangeable tank

9 Intermediate wall

10 Overall housing

11.1, 11.2, 11.3 Partial housing

12.1, 12.2, 12.3 Mounting frame

13 Exhaust system

14 Exhaust outlet

15 Catalyst

16 Exhaust pipe

S1 Power and HMI unit Geometric center

S2 Energy conversion unit Geometric center

S3 Tank unit Geometric center

M1 Module 1

M2 Module 2

M3 Module 3

100 Front

200 Back

300 Left side

400 Right side

500 Top

1. Charging station (1) suitable and intended for charging electric vehicles, with
a housing (10, 11)
a power and HMI unit (2),
wherein the power and HMI unit (2) comprises a display and operating device (6),
wherein the display and operating device (6) has display and/or operating elements (6.1) which are arranged on the front (100) of the housing (10, 11) of the charging station (1),
an energy conversion unit (3),
wherein the energy conversion unit (3) comprises a device (4) for converting a liquid and/or gaseous energy carrier into electrical energy,
characterized in that
the power and HMI unit (2) is arranged between the front (100) of the housing (10, 11) and the energy conversion unit (3).

2. Charging station (1) suitable and intended for charging electric vehicles, according to claim 1
characterized in that
the energy conversion unit (3) comprises a first energy conversion device (4) and/or a second energy conversion device (5).

3. Charging station (1) suitable and intended for charging electric vehicles, according to claim 2
characterized in that
the first energy conversion device (4) is adapted to generate kinetic energy from the liquid and/or gaseous energy carrier, and the second energy conversion device (5) is adapted to convert kinetic energy into electrical energy.

4. Charging station (1) suitable and intended for charging electric vehicles, according to claim 2,
characterized in that
the first energy conversion device (4) is arranged above the second energy conversion device (5).

5. Charging station (1) suitable and intended for charging electric vehicles, according to claim 1,
characterized in that
the display and operating device (6) is arranged above the power and HMI unit (2).

6. Charging station (1) suitable and intended for charging electric vehicles, according to claim 1,
characterized in that
the power and HMI unit (2) and the energy conversion unit (3) are arranged in the housing (10, 11).

7. Charging station (1) suitable and intended for charging electric vehicles, according to claim 1,
characterized in that
the charging station (1) has a tank.

8. Charging station (1) suitable and intended for charging electric vehicles, according to claim 7
characterized in that
the tank is arranged in the housing (10, 11).

9. Charging station (1) suitable and intended for charging electric vehicles, according to claim 7,
characterized in that
the energy conversion unit (3) is arranged between the power and HMI unit (2) and the tank unit (7).

10. Charging station (1) suitable and intended for charging electric vehicles, according to any one or more of claims 7,
characterized in that
an intermediate wall (9) is arranged between the tank unit (7) and the energy conversion unit (3) and/or the power and HMI unit (2).

11. Charging station (1) suitable and intended for charging electric vehicles, according to any one or more of claims 7,
characterized in that
the tank unit (7) is suitable for accommodating one or more interchangeable tanks (8).

12. Charging station (1) suitable and intended for charging electric vehicles, according to claim 1,
characterized in that
the charging station (1) is modular (M1, M2, M3).

13. Charging station (1) suitable and intended for charging electric vehicles, according to claim 12
characterized in that
the charging station (1) comprises the modules (M1, M2, M3) power and HMI unit (2) and energy conversion unit (3) and/or tank unit (7).

14. Charging station (1) suitable and intended for charging electric vehicles, according to claim 12,
characterized in that
the modules (M1, M2, M3) can be connected to each other.

15. Charging station (1) suitable and intended for charging electric vehicles, according to any one or more of claims 12,
characterized in that
the modules (M1, M2, M3) all have the same width.

16. Charging station (1) suitable and intended for charging electric vehicles, according to claim 1,
characterized in that
the charging station (1) has separate partial housings (11).

17. Charging station (1) suitable and intended for charging electric vehicles, according to claim 16
characterized in that
one of the partial housings (11) is constructed from a mounting frame (12).

18. Charging station (1) suitable and intended for charging electric vehicles, according to claim 16,
characterized in that
one module (M1, M2, M3) is arranged in each of the separate partial housings (11).

19. Charging station (1) suitable and intended for charging electric vehicles, according to any one or more of claims 16,
characterized in that
the partial housings (11) are arranged in an overall housing (10),
wherein the overall housing (10) at least partially encloses the partial housings (11).

20. Charging station (1) suitable and intended for charging electric vehicles, according to claim 1,
characterized in that
the charging station (1) has an exhaust system.

21. Charging station (1) suitable and intended for charging electric vehicles, according to claim 20
characterized in that
the exhaust system is arranged in such a way that parts of the exhaust system are located above the energy conversion units (3, 4, 5).

22. Charging station (1) suitable and intended for charging electric vehicles, according to claim 20
characterized in that
the exhaust system has an exhaust outlet,
wherein the exhaust outlet is arranged on the top of the overall housing (10) and/or of a partial housing (11.1, 11.2, 11.3).
